(19) United States
(12) Patent Application Publication
(10) Pub. No.: US 2007/0174391 A1
(43) Pub. Date: Jul. 26, 2007

(54) Distribution device for optimized distribution of short messages to an ip-compatible terminal

(76) Inventors: Stefan Kuchenhoff, OBERHACHING (DE); Stefan Unger, Unterhaching (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/587,772

(22) PCT Filed: Jan. 10, 2005
(86) PCT No.: PCT/EP05/50083

§ 371 Date: Jul. 28, 2006

(30) Foreign Application Priority Data
Jan. 29, 2004 (EP) 04002001.8

(51) Int. Cl. G06F 15/16

(52) U.S. Cl. 709/206; 709/200; 370/352

(57) ABSTRACT

Short messages (SMS) or short messages containing images (MMS) are sent in a reliable, cost-optimized, and time-optimized manner to an IP-compatible terminal, e.g. a set-top box that is connected to a telecommunication network by expanding the functions of the distribution center for SMS/MMS messages and a registration entity for IP connections.

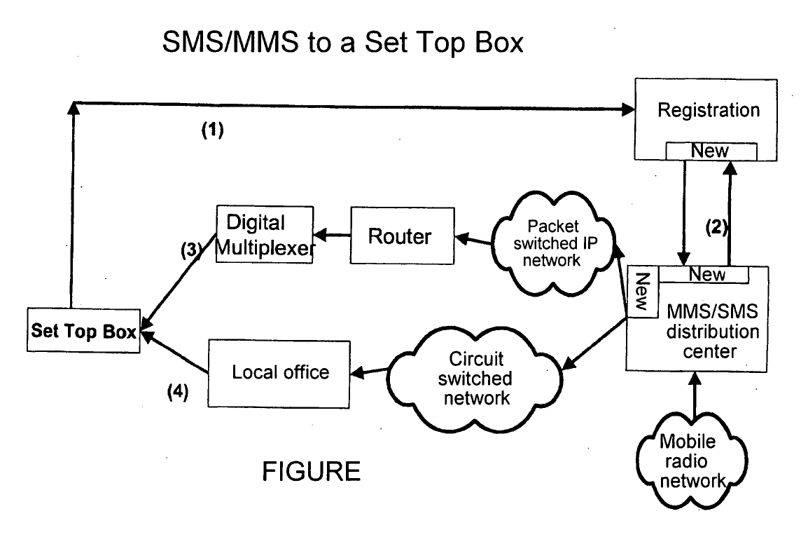

### CROSS REFERENCE TO RELATED APPLICATIONS

This application claims priority of PCT application No. PCT/EP2005/050083 filed Jan. 10, 2005 which claims priority to EP application No. 04002001.8 filed Jan. 29, 2004, both of which are incorporated herein by reference in their entirety.

### FIELD OF THE INVENTION

Reliable and also cost-optimized and time-optimized sending of short messages (SMS) or multimedia messages with images (MMS) to an IP-compatible terminal, e.g. a Set Top Box (STB) or Personal Computer (PC), which is connected via a high-bit-rate line (e.g. DSL or cable) to the telecommunication network. The method better exploits the existing technical options of the transport networks than today's existing solutions.

### BACKGROUND OF THE INVENTION

Possible solutions to the problem presented are

The distribution center (SMS/MMS Service Center) sends the short message over the packet switched IP network through to the subscriber, but the message is discarded if the subscriber is not online. The distribution center has no opportunity to check whether the message has actually arrived. This is generally not an acceptable solution, especially not for operators who impose high demands on the reliability of their service, e.g. fixed network operators.
The distribution center always sends the short message over the circuit switched network. This guarantees that the subscriber also actually gets the message. However this is only possible if the subscriber has subscribed to a PSTN service (i.e. has a splitter at home and possesses a PSTN subscription with a PSTN telephone number). In addition this is generally a very expensive route which requires additional functions in the distribution center. Previously it has not been known how and SMS or MMS can be sent reliably over the most suitable route to an individual Set Top Box.

### SUMMARY OF THE INVENTION

A new communication is introduced into the network between the SMS/MMS distribution center (distribution device) and a registration entity. To do this it is necessary to introduce new functions in both components.

With the aid of this communication relationship the distribution center can ask the registration entity whether the subscriber has currently activated their broadband connection (i.e. is online and has a valid IP address) The distribution center also contains a new coordination function which evaluates the results of the inquiry to the registration entity and sends the short messages in accordance with the available routes to IP-compatible terminal of the subscriber, e.g. an STB.

### BRIEF DESCRIPTION OF THE DRAWINGS

An exemplary embodiment of the invention is explained in greater detail below with reference to the drawing which comprises one figure.

### DETAILED DESCRIPTION OF THE INVENTION

A subscriber possesses an STB, which for example supports the services video on demand, video telephony and also sending and receiving of short messages. An SMS/MMS client is required in the STB for the latter service. The STB is connected via a DSL line to a DSLAM or optionally also via a splitter to the local office. An SMS/MMS Service Center (distribution device) is located in the network, in which the short messages of different subscriber types (e.g. video network subscribers, mobile radio subscribers) are received and forwarded to the addressees. In addition there is a registration entity present in the DSL-based network (e.g. a broadband access router, a radius server or also an SIP Registrar/Server), with which the subscriber can register (see (1) in the Figure), so that the current status of his network access, e.g. of his IP broadband access is recorded there. The status is either “online” i.e. that the subscriber has been assigned an IP address and the PPPoE session is active or the status is “inactive”, i.e. the subscriber has no IP-based connection.

A given subscriber now sends, e.g. sends an MMS from a mobile network to another subscriber which is to be submitted to their STB. The MMS reaches the distribution center. This center now asks the registration entity whether the subscriber is registered, i.e. is “online” (2). If they are the distribution center receives the current IP address of the STB and sends the MMS via the packet switched IP network to the STB (3). To this end the distribution center must pack the MMS into IP packets with the IP address just received.

If the subscriber is not active, the distribution center can buffer the MMS and ask the registration entity at regular intervals whether the status has changed or if possible send the MMS via the circuit-switched network (PSTN) to the STB.(4). To this end it establishes a speech channel to the subscriber for example and sends the MMS in this via a modem connection. This is in general the more expensive variant, which also requires additional functions in the distribution center (e.g. a modem) and is also time-consuming. The aim should be only to use this route if the more favorable DSL route is not available.

The advantages of the invention are as follows. Short messages can be sent reliably to an STB, whereby the possible routes are checked for availability and the short messages are sent over the most suitable route. The selection of the route can take account of costs for transporting the data, data rate and further aspects In particular a check can be made for the more cost-effective transport routes (e.g. via ADSL) as to whether the short messages can really be sent to the subscriber and will not be lost on the way there.

1-5. (canceled)

6. A distribution device for distributing short messages to an IP-compatible terminal, comprising:
a receiving apparatus, which receives a short message to be sent to a subscriber;
an interrogation device in communication with the receiving apparatus which, after the arrival of the short message for the subscriber, asks a registration device for the status of the subscriber whether the subscriber is online; and
a control device, which evaluates the interrogation result and forwards the short message to the subscriber or buffers the message for sending at a later time, depending on the status of the subscriber from interrogation device.

7. The distribution device as claimed in claim 6, wherein the control device forwards the short message to the subscriber over an IP network if the results of the interrogation device reveals that the subscriber is online.

8. The distribution device as claimed in claim 6, wherein the control device buffers the short message for the subscriber if the interrogation device reveals through the registration device that the subscriber is not online and has no access to a circuit switched network, the control device then submits a new request to the registration device through the interrogation device at regular intervals and forwards the short message to the subscriber as soon as the interrogation device reveals that the subscriber is now online.

9. The distribution device as claimed in claim 6, wherein the control device forwards the short message to the subscriber via a circuit switched network if said interrogation reveals that the subscriber is not online.

10. A registration device which registers the status of a subscriber in a network, connected to a distribution device, comprising:
an interface connected to the distribution device for distribution of a short message to an IP-compatible terminal, wherein the interface responds to the request of the distribution device for the status of the network access of the subscriber.

11. The registration device according to claim 10, wherein the subscriber is connected to the system via a set top box communication device generally utilized for media viewing.

12. The registration device according to claim 10, wherein the message is a short message containing text.

13. The registration device according to claim 10, wherein the message is a multimedia message containing images or video or both.

14. A system for ensuring that short messages are not lost in a communication system and allowing the receiving or a short text message to a subscriber comprising:
a registration device that registers whether the subscriber is on-line via a set top box; and
a distribution center that communicates with the registration device when a message is being received for the subscriber to determine if the subscriber is on-line and if the subscriber is on-line then the message is send to the subscriber through an IP network.

15. The system according to claim 14, wherein the distribution center if through the registration device determines the subscriber is not on-line then the distribution center buffers the short message until the subscriber is on-line.

16. The system according to claim 14, wherein the distribution center a regular intervals communicates with the registration device to determine of the subscriber is on-line in order to send the message to the subscriber via the IP network when the subscriber is on-line.

17. The system according to claim 14, wherein the distribution center further comprises:
a receiving apparatus that receives a message to be sent to the subscriber; and
an interrogation device for communicating with the registration device to determine whether the subscriber is online or not.

18. The system according to claim 14, wherein the distribution center through the registration device receives an IP address for the subscriber and send the message via a packet switched IP network to the subscriber.

19. The system according to claim 14, wherein the subscriber is connected to the system via a set top box communication device generally utilized for media viewing.

20. The system according to claim 14, wherein the message is a short message containing text.

21. The system according to claim 14, wherein the message is a multimedia message containing images or video or both.
